(19) United States
(12) Patent Application Publication
(10) Pub. No.: US 2013/0291900 A1
(43) Pub. Date: Nov. 7, 2013

(54) METHOD FOR OPERATING A PUMP IN AN APPLIANCE

(71) Applicant: Mark Thomas Fryman, Louisville, KY (US)

(72) Inventor: Mark Thomas Fryman, Louisville, KY (US)

(73) Assignee: GENERAL ELECTRIC COMPANY, Schenectady, NY (US)

(21) Appl. No.: 13/463,891

(22) Filed: May 4, 2012

(51) Int. Cl. A47L 15/42; B08B 3/04

(52) U.S. Cl. 134/25.2; 134/186

(57) ABSTRACT

An appliance is provided with a pump for drawing liquid from a wash chamber of the appliance. The pump is operated such that the pump cycles on and off during a cycle of the appliance. By cycling on and off, air locks affecting the pump can be eliminated or reduced.

### FIELD OF THE INVENTION

The present subject matter relates generally to appliances with pumps and methods for operating the same.

### BACKGROUND OF THE INVENTION

Dishwasher appliances generally include a drain pump. The drain pump removes liquid (e.g., water, detergent, etc.) from a wash chamber of the appliance. For example, liquid can collect in a sump disposed at a bottom of the wash chamber during operation of the dishwasher appliance. The drain pump can be in fluid communication with the sump such that the drain pump urges liquid from the sump to a drain where the liquid can flow out of the appliance.

During operation, drain pumps can experience a condition called an air lock that negatively affects operation of the drain pump. An air lock is a pocket or bubble of air located within the drain pump or connected piping or hoses. The air lock can prevent or impede the drain pump from creating a flow of liquid out of the wash chamber. Thus, the air lock can severely reduce or completely obstruct the flow of liquid out of the wash chamber.

A design goal for dishwasher appliances can include water and energy conservation. Drain pumps experiencing an air lock do not function at optimum efficiency. For example, a drain pump experiencing an air lock can take a greater amount of time to remove liquid compared to an identical drain pump operating without the air lock. Thus, air locks can contribute to greater energy consumption by the dishwasher appliance.

In addition, air locks can generate greater number of service calls regarding the dishwasher appliance. Due to the negative effects of air locks, appliance owners can attribute the reduced performance on a clog and call a service technician for repair. However, such service calls can be unnecessary due to the transitory nature of the air locks. Thus, air locks can contribute to consumption of valuable service technician and user resources on unnecessary repair calls.

To eliminate air locks, certain drain pumps include features for directing air out of the drain pump. For example, certain drain pumps can be positioned or oriented such that creation of an air lock is hindered. In particular, such drain pumps are constructed to allow air to escape the drain pump and surrounding piping or hoses. However, such designs offer limited reliability in reducing air locks. Thus, such designs can still suffer air locks.

Accordingly, a dishwasher appliance with features for reducing or eliminating air locks within a pump of the appliance would be useful. Also, a dishwasher appliance with features for at least partially removing air locks from a pump of the appliance would be useful

### BRIEF DESCRIPTION OF THE INVENTION

Aspects and advantages of the invention will be set forth in part in the following description, or may be apparent from the description, or may be learned through practice of the invention.

An appliance is provided with a pump for drawing liquid from a wash chamber of the appliance. The pump is operated such that the pump cycles on and off during a cycle of the appliance. By cycling on and off, air locks affecting the pump can be eliminated or reduced.

In a first exemplary embodiment, an appliance is provided. The appliance includes a tub defining a wash chamber for receipt of articles for washing, a drain, and a drain pump in fluid communication with the wash chamber of the tub and the drain. The drain pump is configured for selectively directing liquid out of the wash chamber of the tub to the drain. A processing device is in communication with the drain pump. The processing device is configured for activating the drain pump for a first period of time, deactivating the drain pump for a second period of time, starting the drain pump for a third period of time, stopping the drain pump for a fourth period of time, and initiating the drain pump for a fifth period of time. The steps of activating, deactivating, starting, stopping, and initiating are performed during a drain cycle. The drain cycle has a drain interval. The drain interval includes the first, second, third, fourth, and fifth periods of time.

In a second exemplary embodiment, a method for operating an appliance is provided. The appliance has a drain pump for directing liquid out of a wash chamber of the appliance. The method includes activating the drain pump for a first period of time, deactivating the drain pump for a second period of time, starting the drain pump for a third period of time, stopping the drain pump for a fourth period of time, and initiating the drain pump for a fifth period of time. The steps of activating, deactivating, starting, stopping, and initiating are performed during a drain cycle. The drain cycle has a drain interval. The drain interval includes the first, second, third, fourth, and fifth periods of time.

In a third exemplary embodiment, an appliance is provided. The appliance includes a tub that defines a wash chamber for receipt of articles for washing. A pump is in fluid communication with the wash chamber of the tub. The pump is configured for selectively drawing liquid out of the wash chamber of the tub. A processing device is in communication with the pump. The processing device is configured for: activating the pump for a first period of time; deactivating the pump for a second period of time; starting the pump for a third period of time; stopping the pump for a fourth period of time; and initiating the pump for a fifth period of time. The steps of activating, deactivating, starting, and stopping are performed during an initial portion of a specific cycle of the appliance in order to clear an air lock condition from the pump. The step of initiating is performed during a remainder of the specific cycle of the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a side partial cut-away view of a dishwasher appliance according to an exemplary embodiment of the present subject matter.

FIG. 2 is a schematic view of a fluid system of the dishwasher appliance of FIG. 1.

FIG. 3 illustrates an exemplary method of operating a dishwasher appliance according to an embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

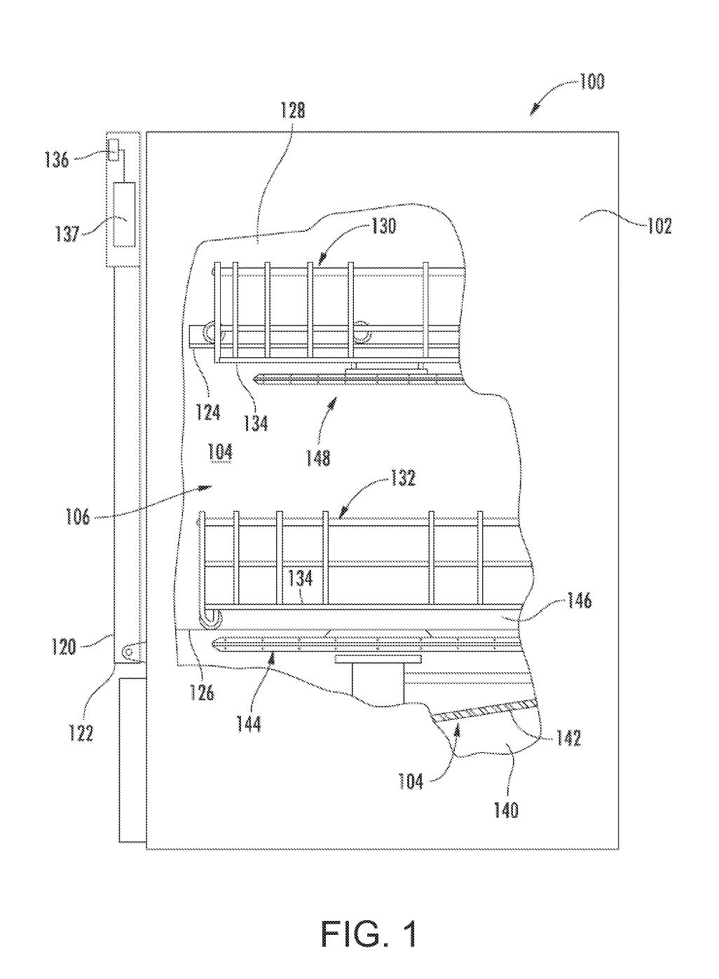

FIG. 1 depicts an exemplary embodiment of a dishwasher appliance 100. Dishwasher appliance 100 includes a cabinet 102 having a tub 104 therein that defines a wash chamber 106. Tub 104 has a door 120 hinged at its bottom 122 for movement between a normally closed vertical position (shown in FIG. 1) wherein wash chamber 106 is sealed shut for washing operation, and a horizontal open position for loading and unloading of articles from wash chamber 106 of dishwasher 100.

Upper and lower guide rails 124, 126 are mounted on tub side walls 128 and accommodate upper and lower roller-equipped racks 130, 132, respectively. Each of upper and lower racks 130, 132 is fabricated into lattice structures including a plurality of elongate members 134, and each rack 130, 132 is adapted for movement between an extended loading position (not shown) in which rack is substantially positioned outside wash chamber 106, and a retracted position (shown in FIG. 1) in which rack is located inside wash chamber 106. A silverware basket (not shown) may be removably attached to lower rack 132 for placement of silverware, utensils, and the like, that are too small to be accommodated by upper and lower racks 130, 132.

Dishwasher 100 further includes a lower spray assembly 144 that is, e.g., rotatably mounted within a lower region 146 of wash chamber 106 and above a tub sump portion 142 so as to rotate in relatively close proximity to lower rack 132. A mid-level spray assembly 148 is located in an upper region of wash chamber 106 and may be located in close proximity to upper rack 130. Additionally, an upper spray assembly (not shown) may be located above upper rack 130.

Lower and mid-level spray assemblies 144, 148 and upper spray assembly are fed by a fluid circulation assembly (not shown) for circulating water and dishwasher fluid in tub 104. The fluid circulation assembly may be located in a machinery compartment 140 located below bottom sump portion 142 of tub 104, as generally recognized in the art. Each spray assembly includes an arrangement of discharge ports or orifices for directing washing fluid onto dishes or other articles located in upper and lower racks 130, 132, respectively. In an exemplary embodiment, the arrangement of the discharge ports in at least lower spray assembly 144 provides a rotational force by virtue of washing fluid flowing through the discharge ports. The resultant rotation of lower spray assembly 144 provides coverage of dishes and other dishwasher contents with a washing spray.

Dishwasher 100 is further equipped with a processing device or controller 137 to regulate operation of dishwasher 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one exemplary embodiment, the processor executes programming instructions stored in memory. The memory may be a separate component from the processor or may be included onboard within the processor.

Controller 137 may be positioned in a variety of locations throughout dishwasher 100. In the illustrated exemplary embodiment, controller 137 may be located within a control panel area of door 120 as shown. In such an embodiment, input/output (“I/O”) signals may be routed between the control system and various operational components of dishwasher 100 along wiring harnesses that may be routed through bottom 122 of door 120. Typically, controller 137 includes a user interface panel 136 through which a user may select various operational features and modes and monitor progress of dishwasher 100. In one exemplary embodiment, user interface 136 may represent a general purpose I/O (“GPIO”) device or functional block. In one exemplary embodiment, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the invention is not limited to any particular style, model, or other configuration of dishwasher, and that the exemplary embodiment depicted in FIG. 1 is for illustrative purposes only. For example, instead of racks 130, 132 depicted in FIG. 1, dishwasher 100 may be of a known configuration that utilizes drawers that pull out from the cabinet and are accessible from the top for loading and unloading of articles. Also, the present subject matter may be utilized in other appliance as well, e.g., washing machine appliances.

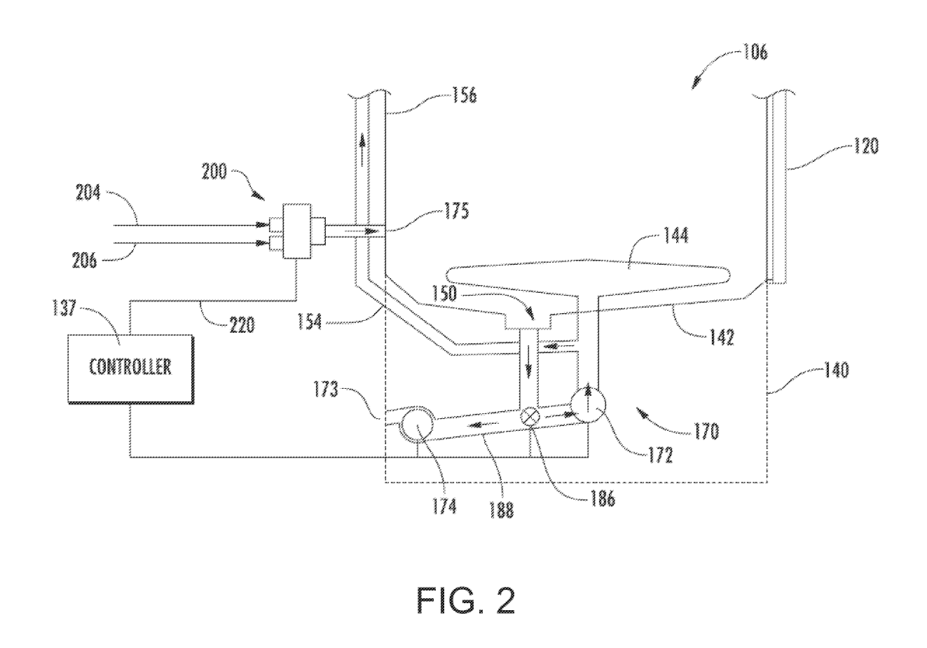

FIG. 2 schematically illustrates an exemplary embodiment of a fluid circulation assembly 170 disposed below the wash chamber 106. Although one exemplary embodiment of fluid circulation assembly 170 that is operable to perform in accordance with aspects of the disclosure is shown, it is contemplated that other fluid circulation assembly configurations may similarly be utilized without departing from the spirit and scope of the invention.

Fluid circulation assembly 170 includes a circulation pump assembly 172 and a drain pump assembly 174, both in fluid communication with sump 150. Additionally, drain pump assembly 174 is in fluid communication with an external drain 173 to discharge used wash liquid, e.g., to a sewer or septic system (not shown). Further, circulation pump assembly 172 is in fluid communication with lower spray arm assembly 144 and conduit 154 which extends to a back wall 156 of wash chamber 106, and upward along back wall 156 for feeding wash liquid to mid-level spray arm assembly 148 (FIG. 1) and the upper spray arm assembly. This configuration also applies to a drawer-type of dishwasher, as mentioned above.

As wash liquid is pumped through lower spray arm assembly 144, and further delivered to mid-level spray arm assembly 148 and the upper spray arm assembly (not shown), washing sprays are generated in wash chamber 106, and wash liquid collects in sump 150. Sump 150 may include a cover to prevent larger objects from entering sump 150, such as a piece of silverware or another dishwasher item that is dropped beneath lower rack 132. A coarse filter and a fine filter (not shown) may be located adjacent sump 150 to filter wash liquid for sediment and particles of predetermined sizes before flowing into sump 150.

A turbidity sensor (not shown) may be coupled to sump 150 and used to sense a level of sediment in sump 150 and to initiate a sump purge cycle where the contents or a fractional volume of the contents of sump 150 are discharged when a turbidity level in sump 150 approaches a predetermined threshold. Sump 150 is filled with water through an inlet port 175 which outlets into wash chamber 106, as described in greater detail below.

Referring to FIG. 2, a water supply 200 may be configured with inlet port 175 for supplying wash liquid to wash chamber 106. Water supply 200 may provide hot water only, cold water only, or either selectively as desired. As depicted, water supply 200 has a hot water inlet 204 that receives hot water from an external source, such as a hot water heater and a cold water input 206 that receives cold water from an external source. It should be understood that the term “water supply” is used herein to encompass any manner or combination of valves, lines or tubing, housing, and the like, and may simply comprise a conventional hot or cold water connection.

As shown in FIG. 2, a drain valve 186 is established in flow communication with sump 150 and opens or closes flow communication between sump 150 and a drain pump inlet 188. Drain pump assembly 174 is in flow communication with drain pump inlet 188 and may include an electric motor for pumping fluid at inlet 188 to an external drain system via drain 173. In one embodiment, when drain pump assembly 174 is energized, a negative pressure is created in drain pump inlet 188 and drain valve 186 is opened, allowing fluid in sump 150 to flow into fluid pump inlet 188 and be discharged from fluid circulation assembly 170 via external drain 173.

Alternatively, drain and recirculation pump assemblies 172 and 174 may be connected directly to the side or the bottom of sump 150, and drain and recirculation pump assemblies 172, 174 may each include their own valving replacing drain valve 186. Other fluid circulation systems are possible as well, drawings fluid from sump 150 and providing fluid as desired within wash chamber 106 or draining fluid out of washing machine 100.

During operation of drain pump assembly 174, an air lock condition can develop within drain pump assembly 174. For example, the air lock condition can develop within drain pump assembly 174 during periods of inactivity by dishwasher appliance 100. The air lock condition can also develop within drain pump assembly 174 when drain pump assembly 174 has completely drained sump 150 and sump 150 is subsequently refilled. As will be understood by those skilled in the art, the air lock condition corresponds to a pocket bubble of air disposed within drain pump assembly 174 or related piping or hoses.

The air lock condition can negatively affect operation of drain pump assembly 174. For example, drain pump assembly 174 has an optimum fluid drain rate. However, when drain pump assembly 174 is experiencing the air lock condition, drain pump assembly 174 operates in a less efficient manner such that fluid drains from sump 150 at a rate below the optimum fluid drain rate. As discussed in greater detail below, dishwasher appliance 100 includes features for clearing or at least partially removing the air lock condition from drain pump assembly 174 such that drain pump assembly 174 operates at a rate at or closer to the optimum fluid drain rate.

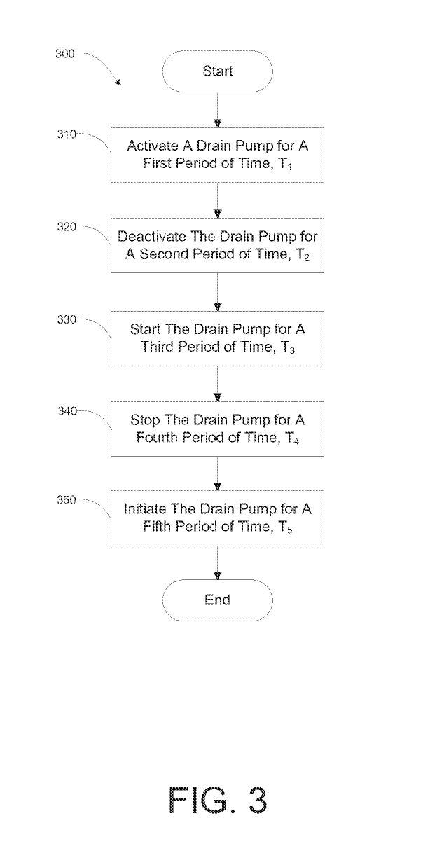

FIG. 3 illustrates a method 300 for operating a dishwasher appliance (e.g., dishwasher appliance 100) in order to improve draining performance. For example, method 300 can clear or at least partially remove an air lock condition from drain pump assembly 174 of dishwasher appliance 100. Controller 137 of dishwasher appliance 100 may be programmed to perform the steps of method 300. Method 300 can be used to clear an air lock condition in other pumps, e.g., circulation pump assembly 172 or a drain pump in a washing machine appliance.

At 310, controller 137 activates drain pump assembly 174 for a first period of time, t₁. Thus, at step 310, drain pump assembly 174 is urging liquid from sump 150 to drain 173 for period t₁. As an example, period t₁ may be about three seconds. However, as discussed in greater detail below, period t₁ may be any suitable period of time, e.g., about one, two, four, five, or more seconds.

At 320, controller 137 deactivates drain pump assembly 174 for a second period of time, t₂. Thus, at step 320, drain pump assembly 174 is not urging liquid from sump 150 to drain 173 for period t₂. As an example, period t₂ may be about one and one-half seconds. However, as discussed in greater detail below, period t₂ may be any suitable period of time, e.g., about one, two, three, four, five, or more seconds.

Steps 310 and 320 correspond to a first drain pulse initiated by controller 137. Thus, in steps 310 and 320, drain pump assembly 174 is turned on for period t₁ and turned off for period t₂. The first drain pulse can assist in clearing or at least partially removing an air lock condition from drain pump assembly 174.

At 330, controller 137 starts drain pump assembly 174 for a third period of time, t₃. Thus, at step 330, drain pump assembly 174 is urging liquid from sump 150 to drain 173 for period t₃. As an example, period t₃ may be about three seconds. However, as discussed in greater detail below, period t₃ may be any suitable period of time, e.g., about one, two, four, five, or more seconds.

At 340, controller 137 stops drain pump assembly 174 for a fourth period of time, t₄. Thus, at step 340, drain pump assembly 174 is not urging liquid from sump 150 to drain 173 for period t₄. As an example, period t₄ may be about one and one-half seconds. However, as discussed in greater detail below, period t₄ may be any suitable period of time, e.g., about one, two, three, four, five, or more seconds.

Steps 330 and 340 correspond to a second drain pulse initiated by controller 137. Thus, in steps 330 and 340, drain pump assembly 174 is turned on for period t₃ and turned off for period t₄. The second drain pulse can assist the first drain pulse in clearing or at least partially removing an air lock condition from drain pump assembly 174.

As discussed above, steps 310-340 correspond to cycling or pulsing drain pump assembly 174 on and off in order to clear or at least partially remove an air lock condition from drain pump assembly 174. Thus, steps 310-340 may be performed as an initial portion of a drain cycle of dishwasher appliance 100 in order to remove an air lock condition that may be present in drain pump assembly 174. Subsequent to steps 310-340, drain pump assembly 174 may operate such that fluid is drained from sump 150 at about the optimum fluid drain rate during a remainder of the drain cycle, e.g., during step 350 described below.

At 350, controller 137 initiates drain pump assembly 174 for a fifth period of time, t₅. Thus, at step 350, drain pump assembly 174 is urging liquid from sump 150 to drain 173 for period t₅. Period t₅ corresponds to a period of time sufficient to remove a particular volume of fluid from sump 150. Thus, period t₅ can vary depending on the type of drain cycle selected. For example, during a full drain cycle when substantially all liquid is removed from wash chamber 106, t₅ corresponds to a period of time sufficient for drain pump assembly 174 to remove substantially all liquid from sump 150. Alternatively, during a partial drain cycle when only a portion of the liquid within sump 150 is removed from sump 150, period t₅ corresponds to a period of time sufficient for drain pump assembly 174 to remove a portion of the volume of liquid within sump 150.

As discussed above, steps 310-340 may be performed during the initial portion of the drain cycle, and step 350 may be performed during the remainder portion of the drain cycle. The entire drain cycle (initial and remainder) may be performed during a drain time interval Δt_{drain}. The interval Δt_{drain} may be calculated as

Δt_{drain}=t₁t₂t₃t₄t₅.

To reiterate, it should be understood that steps 310-350 may be performed during a single drain cycle of appliance 100. Steps 310-340 may be performed to remove an air lock condition, and step 350 may be performed subsequent to steps 310-340 such that drain pump assembly 174 operates at about the optimum fluid drain rate. In particular, the steps of activating 310, deactivating 320, starting 330, and stopping 340 may be performed during the initial portion of the drain cycle to clear any air lock condition, and the step of initiating 350 may be performed during the remainder portion of the drain cycle to drain a volume of liquid from the sump 150 at about the optimum fluid drain rate. Periods t₁, t₂, t₃, t₄, and t₅ of steps 310-350 may be substantially sequential during the drain cycle. However, brief pauses or transition periods may be present between the steps.

It should be understood that steps 310-340 of method 300 may be performed during every drain cycle of appliance 100. Thus, during steps 310-340, an air lock condition may or may not be present in drain pump assembly 174. Thus, drain pump assembly may be operating at the optimum drain rate during steps 310-340 such that steps 310-340 are unnecessary. However, by always performing steps 310-340 in the initial portion of the drain cycle, any air lock conditions that may be present in drain pump assembly 174 will be mitigated.

As will be understood by those skilled in the art, the selection of specific periods t₁, t₂, t₃, and t₄ can vary depending upon the specific geometry of drain pump assembly 174. Thus, periods t₁, t₂, t₃, and t₄ may be tuned for various drain pump assemblies. However, in various exemplary embodiments, periods t₁ and t₃ may be greater than periods t₂ and t₄ or vice versa. Further, periods t₁ and t₃ may be about equal. Also, periods t₂ and t₄ may be about equal.

Method 300 may further include additional pulses or cycles to purge an air lock condition from drain pump assembly 164. For example, in FIG. 3, method 300 includes two pulses. However, method 300 can include any suitable number of additional pulses when the geometry of drain pump assembly 174 requires, e.g., one, two, or more additional pulses.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
a tub defining a wash chamber for receipt of articles for washing;
a drain;
a drain pump in fluid communication with the wash chamber of said tub and said drain, said drain pump configured for selectively directing liquid out of the wash chamber of said tub to said drain;
a processing device in communication with said drain pump, said processing device configured for:
activating said drain pump for a first period of time;
deactivating said drain pump for a second period of time;
starting said drain pump for a third period of time;
stopping said drain pump for a fourth period of time; and
initiating said drain pump for a fifth period of time, wherein said steps of activating, deactivating, starting, stopping, and initiating are performed during a drain cycle, the drain cycle having a drain interval, the drain interval comprising the first, second, third, fourth, and fifth periods of time.

2. The appliance of claim 1, wherein the first period time and the third period of time are about equal.

3. The appliance of claim 2, wherein the first and third time periods are about three seconds.

4. The appliance of claim 1, wherein the second period time and the fourth period of time are about equal.

5. The appliance of claim 4, wherein the second and fourth time periods are about one and one-half seconds.

6. The appliance of claim 1, wherein the first and third time periods are greater than the second and fourth time periods.

7. The appliance of claim 1, wherein the first, second, third, fourth, and fifth periods of time are substantially sequential.

8. The appliance of claim 1, wherein said drain pump is disposed adjacent a sump of said tub.

9. The appliance of claim 1, further comprising a rack assembly received within the wash chamber of said tub, wherein the appliance is a dishwasher appliance.

10. A method of operating an appliance, the appliance having a drain pump for directing liquid out of a wash chamber of the appliance, the method comprising:
activating the drain pump for a first period of time;
deactivating the drain pump for a second period of time;
starting the drain pump for a third period of time;
stopping the drain pump for a fourth period of time; and
initiating the drain pump for a fifth period of time, wherein said steps of activating, deactivating, starting, stopping, and initiating are performed during a drain cycle, the drain cycle having a drain interval, the drain interval comprising the first, second, third, fourth, and fifth periods of time.

11. The method of claim 10, wherein the first period time and the third period of time are about equal.

12. The method of claim 11, wherein the first and third time periods are about three seconds.

13. The method of claim 10, wherein the second period time and the fourth period of time are about equal.

14. The method of claim 13, wherein the second and fourth time periods are about one and one-half seconds.

15. The method of claim 10, wherein the first and third time periods are greater than the second and fourth time periods.

16. The method of claim 15, wherein the first and third time periods are about three seconds and the second and fourth time periods are about one and one-half seconds.

17. The method of claim 10, wherein the first, second, third, fourth, and fifth periods of time are substantially sequential.

18. An appliance comprising:
a tub defining a wash chamber for receipt of articles for washing;
a pump in fluid communication with the wash chamber of said tub, said pump configured for selectively drawing liquid out of the wash chamber of said tub;
a processing device in communication with said pump, said processing device configured for:
activating said pump for a first period of time;
deactivating said pump for a second period of time;
starting said pump for a third period of time;
stopping said pump for a fourth period of time; and
initiating said pump for a fifth period of time, wherein said steps of activating, deactivating, starting, and stopping are performed during an initial portion of a specific cycle of the appliance in order to at least partially remove an air lock condition from said pump, wherein said step of initiating is performed during a remainder of the specific cycle of the appliance.

19. The appliance of claim 19, wherein the first, second, third, fourth, and fifth periods of time are substantially sequential.
